(19) United States
(12) Patent Application Publication
(10) Pub. No.: US 2005/0037171 A1
(43) Pub. Date: Feb. 17, 2005

(54) Plastic tube container with lid

(76) Inventor: Ming-Yuan Wang, Tainan (TW)

Correspondence Address: Hsu & Associates, P.O. Box 72, Nankang, Taipei, 115, TW

(21) Appl. No.: 10/643,114

(22) Filed: Aug. 16, 2003

(51) Int. Cl. B32B 1/08

(52) U.S. Cl. 428/36.9

(57) ABSTRACT

A plastic tube container with a lid includes a tube body, a tube head and a lid. The tube head is integrally joined to the top of the tube body with an opening thereof being covered by the lid. The tube body is made of soft plastics and the tube head can be made of hard plastics or soft plastics. The receiving space of the tube head straightforward communicates the containing space of the tube body. Further the lid can have an operating point to be arranged at a desirable position for being operated easily with a hand.

### BACKGROUND OF THE INVENTION

1. Field of the Invention

The present invention relates to a plastic tube container. In particular, the present invention relates to a plastic tube container with a lid.

2. Description of Related Art

The plastic tube container is frequently used for containing and packaging preparations such as cosmetics and personal clean and health care stuffs. A traditional plastic tube container as shown in FIG. 4 usually includes a soft tube body 1 and a tube cover 2. The tube cover 2 is generally integrated with injected hard plastics and the tube body 1 is integrated with injected polyethylene. In order to join the tube body 1 and the tube cover 2, a tube top 3 is formed with an outlet after the tube body 1 being drawn. Then, the tube cover 2 is mounted to the tube top 3. To fabricate the traditional plastic container, it is necessary to make the tube with drawing, connect the tube top, arrange the opening, inject the tube cover 2 and assemble the tube body 1 and the tube cover 2 together so that the process for making the tube container is sophisticate and it is material-wasteful and costly.

Further, the tube cover 2 is connected to the tube top 3 by way of screw thread such that it is inconvenient to be opened with a hand while in use. In addition, the tube cover 2 is easy to become loosening due to screw thread connection being incapable of firm engagement between the tube cover 2 and the tube top 3 and it frequent to occur a problem of the contained stuff leaking from the container.

### SUMMARY OF THE INVENTION

The crux of the present invention is to provide a plastic tube container with a lid, which includes a tube body, a tube head and a lid with the tube head being integrally joined to the top of the tube body with an opening being covered by the lid. The tube body is made of soft plastics and the tube head is made of hard plastics or soft plastics. The receiving space of the tube head straightforward communicates the containing space of the tube body. Further, the lid has an operating point to be arranged at a desirable position so that operating point can be pressed easily with a hand.

Accordingly, an object of the present invention is that the tube head is integrally made with the tube body to enhance the production efficiency and lower the production cost.

Another object of the present invention is that the tube head is integrally made with the tube body to avoid tedious fabricating process and save material effectively.

A further object of the present invention is that the receiving space of the tube head can be sufficiently occupied and the receiving space of the tube head straightforward communicates the containing space of the tube body so that the plastic container of the present invention has a larger inner space for receiving and containing the filled stuff than the conventional plastic tube container.

A further object of the present invention is that the operating point of the lid can be arranged at a needed position so that a hand can hold the tube body with a finger pressing the operating point conveniently.

### BRIEF DESCRIPTION OF THE DRAWINGS

The detail structure, the applied principle, the function and the effectiveness of the present invention can be more fully understood by referring to the following description and accompanying drawings, in which:

FIG. 1 is a perspective view of a plastic tube container with lid according the present invention;

FIGS. 2a, 2b and 2c are a front view, a side view and a sectional view of the plastic tube container shown in FIG. 1, respectively;

FIGS. 3a, 3b and 3c are a front view, a side view and a top view of the present invention in another embodiment thereof, respectively; and

FIG. 4 is a fragmentary sectional view of a conventional plastic tube container.

### DETAILED DESCRIPTION OF THE PREFERRED EMBODIMENT

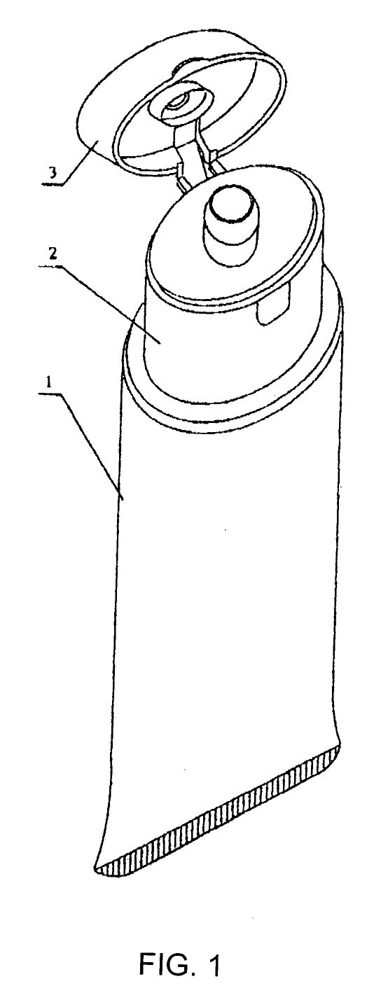

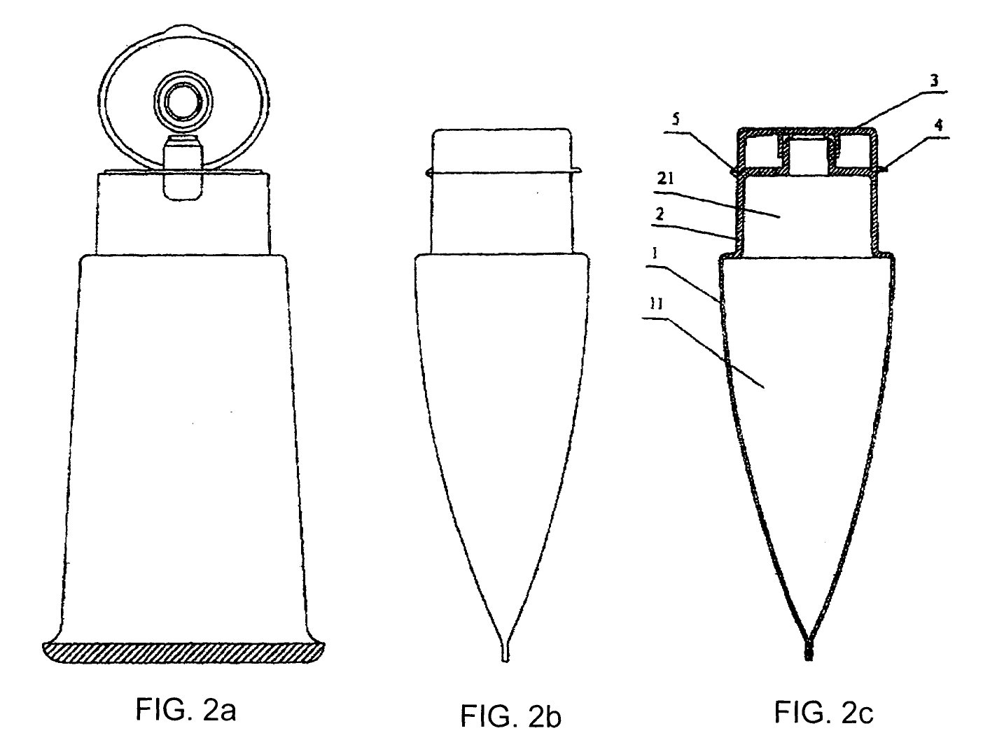

Referring to FIGS. 1, 2a, 2b and 2c, the first embodiment of present invention is an easily lifted plastic tube container, which has a tube body 1 with a cylindrical or a flat shape and the tube body 1 has a closed lower end and an tube head 2 is integrally made with the tube body 1 at the top thereof. The tube head 2 has an opening and a lid 3 is attached with a hinge 5, which is joined to the tube head 2 at the circumferential side thereof. The lid 3 has a covering recess for fitting with the opening of the tube head 2. A lift tab 4 is integrally attached to the lid 3 at the periphery thereof and the lift tab 4 is disposed at the front side of the tube body 1 so as to facilitate the lid 3 being opened while the container is in use.

The tube body 1 is made of soft plastics and the tube head 2 can be made of hard plastics or soft plastics. It can be seen in FIG. 2c that the receiving space 21 of the tube head 2 straightforward communicates the containing space 11. The inner space of the tube head 2 can sufficiently occupied so that the receiving space 21 and the containing space 11 are bigger than those used in the traditional product.

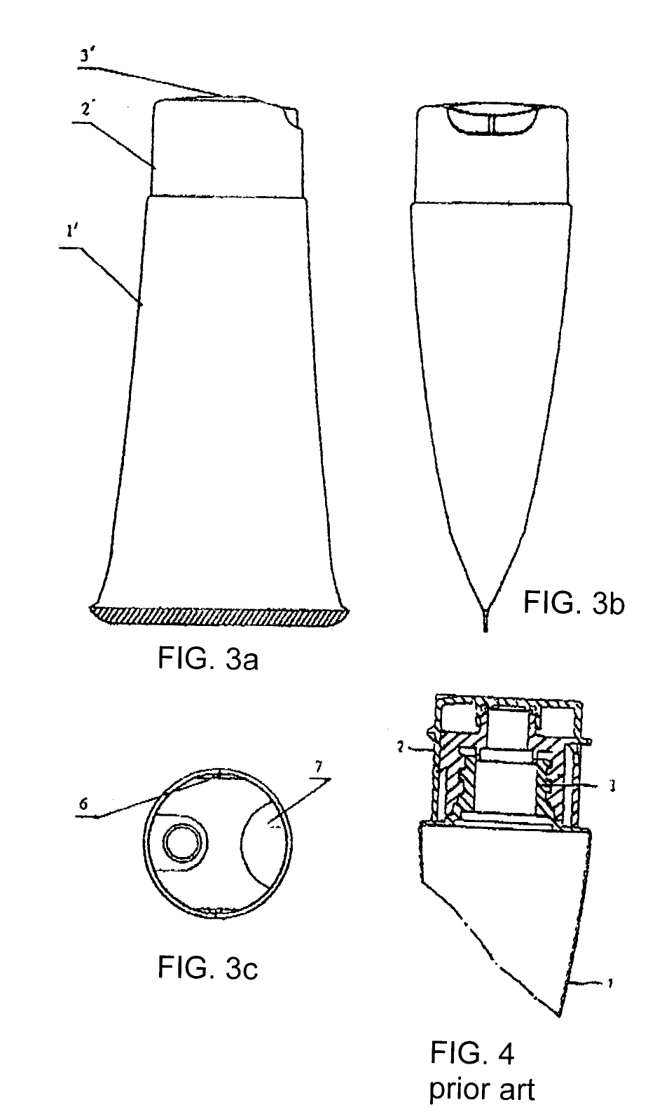

Referring to FIGS. 3a, 3b and 3c, a second embodiment of the present invention illustrated. The plastic tube container of the second embodiment has a tube body 1′ and a tube head 2′, which is integrally disposed at the top of the tube body 1′. A turned lid 3′ is disposed at the top of the tube head 2′ and joined to the tube head 2′ via a pin shaft 6. An operating point 7 of the turned lid 3′ is disposed at a lateral side of the tube body 1′ to facilitate the turned lid 3′ being opened with a hand. While in use, the turned lid 3′ can be stirred to allow the stuff filled in the container being squeezed out easily.

It is noted that the operating point 7 can be disposed at a desirable spot so that the tube body 1 can be held with a hand and the operating point 7 can be pressed with a finger.

Comparing with the traditional plastic tube container, the plastic container of the present invention is fabricated much more simply. Further, there are no screw threads are provided for engaging the tube head to the tube cover so that it save a lot of plastic material and production cost.

While the invention has been described with referencing to preferred embodiments thereof, it is to be understood that modifications or variations may be easily made without departing from the spirit of this invention, which is defined by the appended claims.

1. A plastic tube container, comprising:
a tube body; and
a tube head, being integrally attached to a top of the tube body;
characterized in that a lid is provided at an opening of the tube head.

2. The plastic tube container as defined in claim 1, wherein the tube body is made of soft plastics and the tube head is made of hard plastics or soft plastics.

3. The plastic tube container as defined in claim 1, wherein the tube head has a receiving space straightforward communicating a containing space in the tube body.

4. The plastic tube container as defined in claim 1, wherein the lid has a covering recess for fitting with an opening of the tube head and being joined to the tube body with a hinge with a lift tab disposed at a periphery of the lid.

5. The plastic tube container as defined in claim 4, wherein the lift tab is arranged at a front side of the tube body.

6. The plastic tube container as defined in claim 4, wherein the lid is a turned lid with a preset opening.
